(19) United States
(12) Patent Application Publication
(10) Pub. No.: US 2006/0014562 A1
(43) Pub. Date: Jan. 19, 2006

(54) Integrated management of a wireless network

(76) Inventors: Pavel Syrtsov, San Francisco, CA (US); Vikranth Reddy, Foster City, CA (US); Janakiraman Gopalan, San Jose, CA (US); Varadachari Rengarajan, San Jose, CA (US); Srinivas Mandyam, San Jose, CA (US); Krishna Vedati, San Jose, CA (US); Kelvin Chong, San Jose, CA (US)

Correspondence Address: Fay Kaplun & Marcin, LLP, Suite 702, 150 Broadway, New York, NY, 10038, US

(21) Appl. No.: 10/891,572

(22) Filed: Jul. 15, 2004

(51) Int. Cl. H04Q 7/20

(52) U.S. Cl. 455/556.2

(57) ABSTRACT

Described is a system including a receiving element receiving monitored attributes from a plurality of devices in a network, a storing element storing the monitored attributes, wherein corresponding attributes from the plurality of devices are stored using standard attributes names and an output element outputting the monitored attributes to a user.

### INCORPORATION BY REFERENCE

U.S. patent application, entitled “Service Oriented Platform Architecture for a Wireless Network,” filed on an even date herewith is assigned to the Assignee of the present application and is expressly incorporated herein, in its entirety, by reference.

### BACKGROUND INFORMATION

Wireless networks are deployed in a great number of industries such as retail environments, transportation and logistics, manufacturing, warehousing, etc. These wireless networks may include large numbers of mobile units, wireless switches and access points. To maintain these networks routine tasks such as component roll-outs, updates, maintenance, support, etc. need to be performed. However, as the networks grow, the performance of these routine tasks becomes unwieldy. This may become a barrier to growth and result in the underutilization of the wireless network.

### SUMMARY OF THE INVENTION

A system including a receiving element receiving monitored attributes from a plurality of devices in a network, a storing element storing the monitored attributes, wherein corresponding attributes from the plurality of devices are stored using standard attributes names and an output element outputting the monitored attributes to a user.

Furthermore, a method including receiving monitored attributes from a plurality of devices in a network, storing the monitored attributes, wherein corresponding attributes from the plurality of devices are stored using standard attributes names and outputting the monitored attributes to a user.

In addition, a wireless device including a protocol for communicating with a network device and a wireless agent collecting monitored attributes from the wireless device and transmitting, via the protocol, the monitored attributes to the network device.

### BRIEF DESCRIPTION OF THE DRAWINGS

FIG. 1 shows an exemplary network including a wireless network which may implement an exemplary embodiment according to the present invention.

FIG. 2 shows an exemplary mobile unit including a wireless agent according to the present invention.

FIG. 3 shows an exemplary communication path between network devices according to the present invention.

FIG. 4 shows an exemplary method for processing attributes received by the IWM system according to the present invention.

FIG. 5 shows exemplary information stored by the IWM system according to the present invention.

FIG. 6 shows an exemplary system diagram according to the present invention.

FIG. 7 shows an exemplary user interface display screen displaying attributes according to the present invention.

FIG. 8 which shows an exemplary method for device discovery according to the present invention.

FIG. 9 shows a second exemplary user interface display screen for displaying network assets according to the present invention.

### DETAILED DESCRIPTION

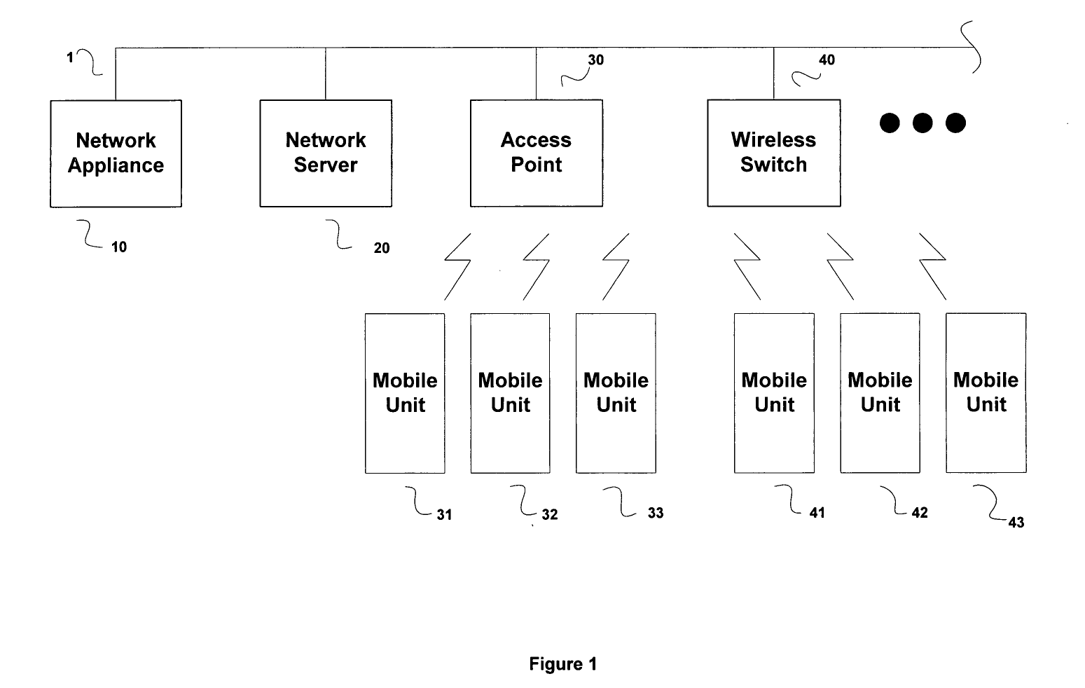

The present invention may be further understood with reference to the following description and the appended drawings, wherein like elements are provided with the same reference numerals. FIG. 1 shows an exemplary network 1 including a wireless network which may implement an exemplary embodiment of the present invention. The network 1 includes a network appliance 10, a network server 20, an access point 30 and a wireless switch 40. Each of these devices are shown as interconnected via a wired portion of the network 1. However, those of skill in the art will understand that these devices may also be wirelessly connected to the network 1. In addition, network 1 may also include any number of additional network components and/or devices (not shown).

FIG. 1 also shows mobile units 31-33 wirelessly connected to the network 1 via the access point 30. The mobile units 31-33 may be any type of computing or processor based device such as desktop or laptop computers, personal digital assistants, mobile phones, pagers, scanners, etc. The mobile units 31-33 and access point 30 may operate within any type of wireless networking environment, e.g., Wireless Local Area Network (“WLAN”), Wireless Wide Area Network (“WWAN”), etc. Communication between the mobile units 31-33 and the access point 30 may be accomplished using any wireless protocol such as IEEE 802.11, Bluetooth, etc. Similarly, mobile units 41-43 are wirelessly connected to the network 1 via the wireless switch 40. Those of skill in the art will understand that the network 1 is only exemplary and that the exemplary embodiment of the present invention may be implemented on any network which includes a wireless portion.

The following is a brief description of an exemplary operation of the network 1 in the context of retail outlet having an on-site warehouse. This example provides a general description of exemplary interactions between the various devices on the network 1. It may be considered that the access point 30 is located in the retail space. The mobile units 31-33 may be portable check out devices used by clerks in the retail space. The wireless switch 40 may be located in the warehouse space with the mobile units 41-43 being handheld computing devices used by the warehouse personnel.

The network server 20 may contain information about products that are sold by the retail outlet. The network server 20 may be in contact with the mobile units 31-33 and 41-43 to keep the information current. For example, the network server may contain the current quantity of product A in the retail space and an inventory rule which states the minimum quantity for product A in the retail space. When a clerk uses mobile unit 31 to checkout a customer purchasing product A, the mobile unit 31 may transmit a message to the access point 30 indicating that one unit of product A had been sold. The access point 30 may then relay this message to the network server 20 which may update its records by removing one unit from the current quantity of product A in the retail space.

The network server 20 may then compare the current quantity to the inventory rule having the minimum quantity. If the current quantity is less than the minimum quantity, the network server 20 may format and send a message to the mobile unit 41 via the wireless switch 40. The message may indicate to the user of the mobile unit 41 that additional quantities of product A need to be moved from the warehouse to the retail space. The user of the mobile unit 41 may send an acknowledgment to the message after having moved the additional quantity of product A from the warehouse to the retail space. The network server 20 may then update the various information it includes based on receiving the acknowledgment, e.g., quantity in retail space and warehouse space.

The above described use of the network 1 is only exemplary and those of skill in the art will understand that the exemplary embodiment of the present invention may be used on any network having a wireless portion regardless of the specific implementation of the network or the applications being run on the network.

However, the above described example illustrates some of the issues that are faced in the control and management of a network including wireless devices. Examples include that the owner of the network 1 may desire to add new devices, e.g., mobile units, access points, wireless switches, etc. The owner may desire to ensure that each of the mobile units includes the same version of software applications or update the applications on the mobile units.

Furthermore, the owner may desire to diagnose and resolve network problems either locally or remotely, e.g., slow response time. More effective monitoring would also allow the owner to diagnose problems before they occur so that they can be prevented. A host of other issues also arise such as the possible intermittent connectivity of mobile devices, security, application development, etc.

The exemplary embodiment of the present invention allows the owner of the network to address all of these issues and a variety of other issues relating to wireless networks by providing the owner with a complete end-to-end view of the entire network. The exemplary embodiment of the present invention is an integrated wireless device and network management system. A main portion of the exemplary embodiment of the integrated wireless device and network management system will be described as residing on the network appliance 10 of the network 1. However, those of skill in the art will understand that the system may reside on any of a variety of devices in the network 1, e.g., network server 20.

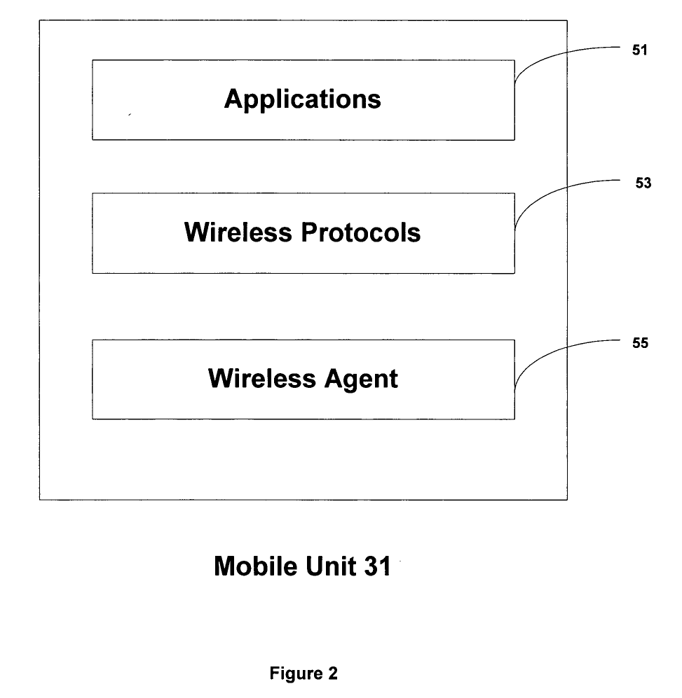

FIG. 2 shows an exemplary mobile unit 31 from the network 1 described with reference to FIG. 1. The mobile unit 31 includes various software components including applications 51, wireless protocols 53 and a wireless agent 55. Other software components may also be included in the mobile unit 31, e.g., an operating system. The applications 51 are those software components which allow the mobile unit 31 to perform the desired functionality, e.g., a check out application from the above described example. The wireless protocols 53 are the software components which allow the mobile unit 31 to communicate with the access point 30 or other mobile units.

The wireless agent 55 is a software component that includes functionality for the integrated wireless device and network management system according to the present invention. The wireless agent 55 resides on each of the mobile units in the network 1 (e.g., mobile unit 31) and collects information on the mobile unit. The wireless agent 55 may collect information or attributes such as battery level, available memory, receiving/transmission bandwidth, etc. There are any number of examples of attributes which may be collected by the wireless agent 55 including, but not limited to, scanning attributes (e.g., number of good decodes, number of bad decodes, most recent scan, most recent scan length, etc.), wireless signal attributes (e.g., signal quality, signal strength, etc.), wireless throughput attributes (e.g., average link speed, bytes sent, bytes received, current link speed, etc.), user authentication attributes (e.g., login count, login failures, etc.), etc. Those of skill in the art will understand that the above attributes are only exemplary and that there may be hundreds or even thousands of attributes which may be collected for any given device. Additional examples of attributes will be provided below. Each of the mobile units 31-33 and 41-43 of the network 1 will include a separate wireless agent 55 to collect such information on the individual mobile unit.

Thus, the wireless agent 55 may receive inputs from a variety of sources within the mobile unit 31 in order to collect this information on the mobile unit 31. For example, the operating system of the mobile unit 31 may monitor the battery level. The wireless agent 55 may query the operating system or receive an input from the operating system to determine the current state of the battery life. In a further example, the wireless agent 55 may query or receive an input from the wireless protocols 53 which indicates the current transmission bandwidth of the mobile unit 31. The wireless agent 55 becomes the central repository in the mobile unit 31 for all the monitored attributes.

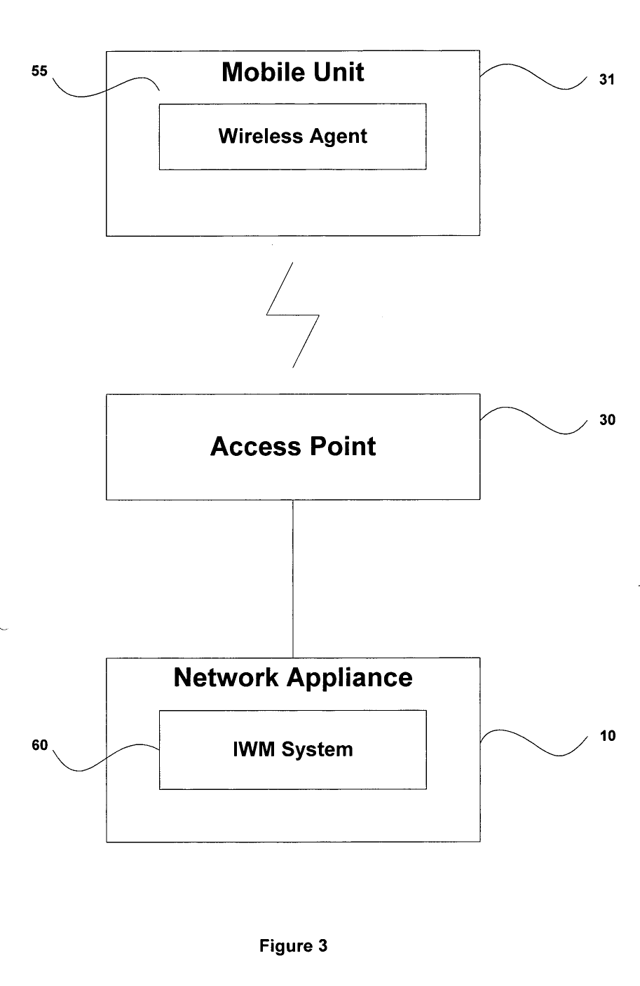

FIG. 3 shows an exemplary communication path between network devices. In this example the communication path is between the mobile unit 31 the access point 30 and the network appliance 10. As described above and as will be described in greater detail below, the communication path operates bi-directionally, i.e., the network appliance 10 may send messages to the mobile unit 31 and vice versa. The network appliance 10 is shown as including an Integrated Wireless Management (“IWM”) system 60 which is a portion of the exemplary embodiment of the present invention. The features and functionality of the IWM system 60 will be described in greater detail below.

In this example, the information that is collected by the wireless agent 55 is communicated to the IWM system 60 on the network appliance 10. The frequency of the transmitted information may vary based on the information that is being transmitted. For example, one of the monitored attributes may be the version of each of the software applications 51 resident on the mobile unit 31. In such a case, this information may only need to be transmitted when there is a change in the version number. On the other hand, monitored attributes such as battery level and transmission bandwidth change more frequently and, thus, the wireless agent 55 may transmit these attributes almost continuously to the IWM system 60.

The wireless agent 55 which is included in each device may include a set of policies to determine when attributes are transmitted to the IWM system 60. As described above, a software application update may trigger a transmission. For example, a policy may be set for mobile devices on a LAN or a WAN to collect certain attributes every 15 minutes. The policy may indicate the specific attributes to be collected based on this policy. The attributes may include: Current AC Power Line Status, Main Battery level, Main Battery status, Backup Battery level, Backup Battery status, Device IP address, Device MAC address, DHCP server address, Gateway address, Network health, Network state, Memory load, Free program memory, Total program memory, Free storage memory and Total storage memory.

In a further example a policy may be set to collect static information from the mobile device. This policy may include the collection of attributes such as: Boot Loader Version, Host Name, OEM Model, OEM Version, OS Build Number, OS Version, Owner, Platform OS Model and Device unit Identifier. Another policy may be set to collect system boot and performance attributes such as: Boot Count, Total Device On Seconds, CPU Usage, Performance Measurement Interval, Performance Samples, Average Thread Latency, Average UI-Thread Latency.

A final example of a policy may be a policy for th collection of wireless association attributes such as: Wireless BSSID, Wireless Channel, Wireless ESSID and Wireless Association status. As these examples show, any number of policies may be implemented for the collection of attributes. These policies may include the attributes which should be collected and when these attributes should be collected.

In addition, there may be other considerations for the transmission of the attributes from the wireless agent 55 to the IWM system 60. For example, each transmission from the mobile unit 31 requires certain system resources, e.g., processor time, battery power, bandwidth, etc. Thus, the number and type of attribute transmissions may be controlled based on the most effective use of device and system resources. The transmission of the attributes may be in any form, for example, the attributes may be transmitted as an XML document over the HTTP protocol. Those of skill in the art will understand that there are any number of other manners which may be used for the actual transmission of the attributes from the devices.

Furthermore, the mobile units 31-33 and 41-43 may have intermittent connectivity to the network 1. This intermittent connectivity may be for a variety of reasons such as the mobile unit has moved out of range of its access point or wireless switch, bandwidth limitations have stopped communications, the device has been turned off, etc. In cases where the mobile unit 31 has lost contact with the network 1, the wireless agent 55 may store the attributes in a buffer or other storage mechanism for later communication when the mobile unit 31 re-establishes connectivity with the network 1.

The IWM system 60 receives these attribute communications from each of the wireless agents 55 resident on the mobile units and stores the information on the network appliance 10. The IWM system 60 stores this information for all the wireless devices on the network 1, e.g., mobile units 31-33 and 41-43.

Each of the network devices e.g., mobile units 31-33 and 41-43, access point 30 and wireless switch 40, may be provided by different vendors and, as such, may have different operating systems and other software components. Thus, when the IWM system 60 receives the attributes from the wireless agent 55, each attribute may have a different naming convention based on the component vendor. For example, the attribute name for battery level in mobile unit 31 from vendor A may be different from the attribute name for battery level in mobile unit 32 from vendor B. Therefore, when the IWM system 60 receives the attributes from the different devices, it will translate the attributes into a uniform system for the entire network 1.

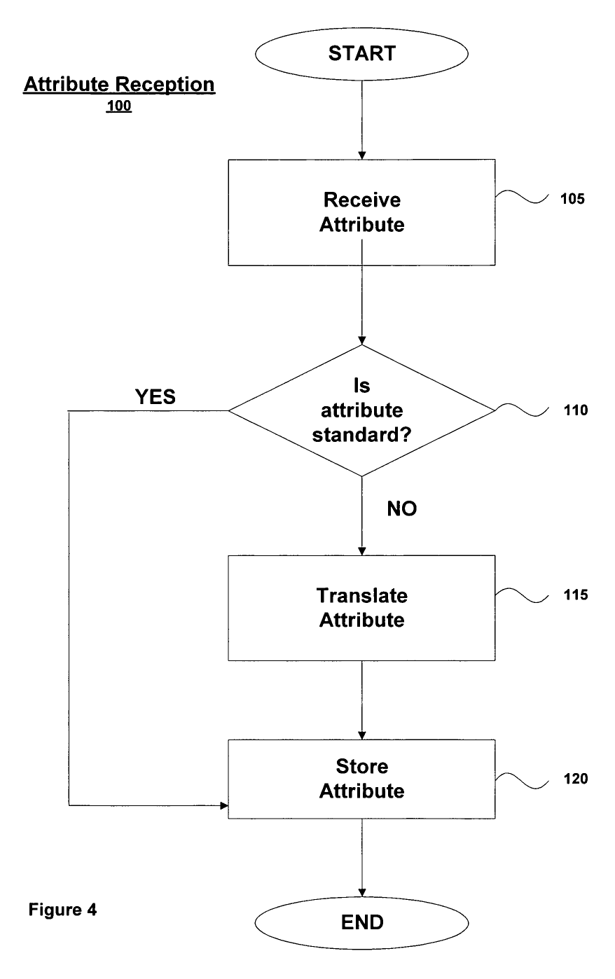

FIG. 4 shows an exemplary method 100 for processing attributes received by the IWM system 60. As described above, in step 105, the IWM system 60 receives the attributes from the wireless agents 55 that are resident on the network devices. In step 110, the IWM system 60 determines whether each of the received attributes is a standard attribute.

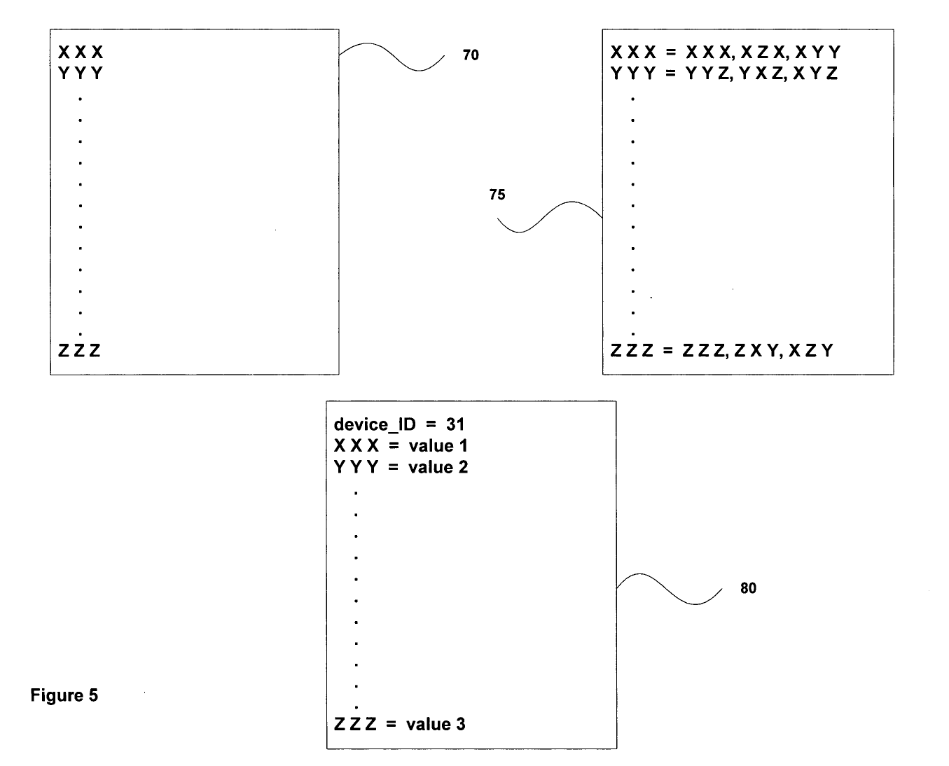

FIG. 5 shows three sets of exemplary information stored by the IWM system 60. The data 70 is a listing of the standard attribute names for the network 1, e.g., attribute names XXX, YYY, ZZZ. Therefore, when the IWM system 60 receives attributes from a wireless agent 55, it compares the attribute name to the list of standard attribute names for the network 1 to determine if the wireless agent 55 reported an attribute with a standard name.

If the attribute does not have a standard name, the process continues to step 115 where the attribute name is translated into the standard attribute name. As shown in FIG. 5, the IWM system 60 may also maintain data 75 which is a listing of attribute names which correlate to the standard attribute name. For example, the standard attribute name for battery level for the network 1 may be XXX as stored in data 70. However, data 75 may store alternate attribute names for battery level as reported by the devices in the network 1. In this example, there are three alternate names for battery level, xxx, xzx, xyy. If the mobile unit 31, through its wireless agent 55, reported battery level having an attribute name xzx, the IWM system 60, using data 75 can translate the non-standard attribute name xzx to the standard attribute name XXX.

The correlations included in the data 75 may be entered by the system administrator or automatically updated when new devices or device types are added to the network 1. For example, when a new device is added to the network 1, the system administrator may be provided with a listing of the attributes for the device. The system administrator may then update the data 75 to include the required correlations for the new device. Automatic updates may be performed based on previous experience, e.g., the IWM system 60 may recognize non-standard attribute names because it already includes devices from the same vendor. In such cases, the system administrator may be prompted for only those non-standard attribute names for which a correlation cannot be determined.

After the received attribute has been translated in step 115 or if the attribute was received with a standard name in step 110, the process continues to step 120 where the IWM system 60 will store the attributes for the device. Again, FIG. 5 shows data 80 which is attribute data that is stored for mobile unit 31 as shown by the device_ID which equals 31. The IWM system 60 stores values for each of the attributes which are reported for the mobile unit 31, e.g., XXX=value1, YYY=value2, ZZZ=value3, etc. At the end of the process 100, the IWM system 60 has stored the attributes for the devices on network 1. This process will be carried out each time the IWM system 60 receives attributes from the various devices, including the updating of any previously stored attributes.

The data 70, 75 and 80 shown in FIG. 5 may be stored in various manners in the IWM system 60. For example, the data may be stored in a database, a table, an array, etc. Those of skill in the art will also understand that the translation system described above is only exemplary and there may be other manners of translating the attribute data. For example, the attribute data may be received by the IWM system 60 including a device identifier or a device type. The IWM system may store a translation table for each device or device type to perform the translation. Other examples of translation will be apparent to those skilled in the art.

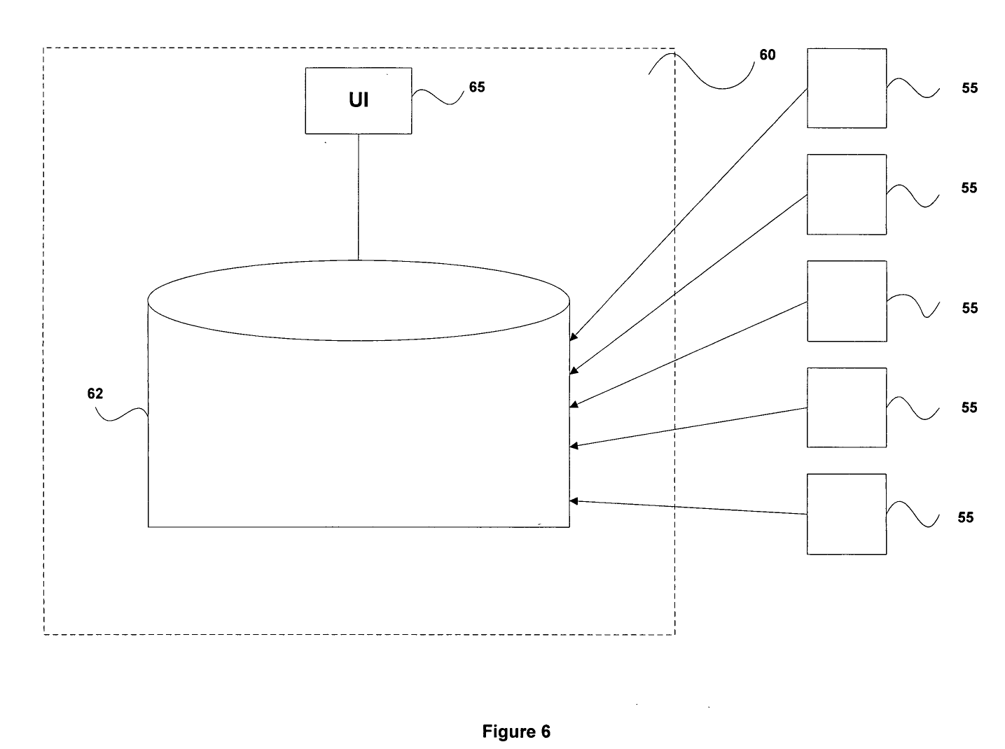

FIG. 6 shows an exemplary system diagram which shows the various components of the exemplary embodiment of the present invention. The IWM system 60 receives all the attribute information from a series of wireless agents 55 which are included on the devices of the network 1. The IWM system 60 stores the attribute information in a central location 62 so that a system administrator may interact with the IWM system 60 to carry out various functions on the network 1. The interaction may take place via a user interface 65 which is part of the IWM system 60.

The network appliance 10 may include outputs for a display device, a printer, etc. and inputs to receive commands from a keyboard, a mouse, etc. The system administrator may view the network information, e.g., the attributes, on a display connected to the network appliance 10 and interact with the IWM system 60 using the attached keyboard. Those of skill in the art will understand that the user interface 65 may take other forms. For example, the network appliance may include an interface to which a computing device is attached and the attached computing device along with its peripheral device may be used as the user interface 65.

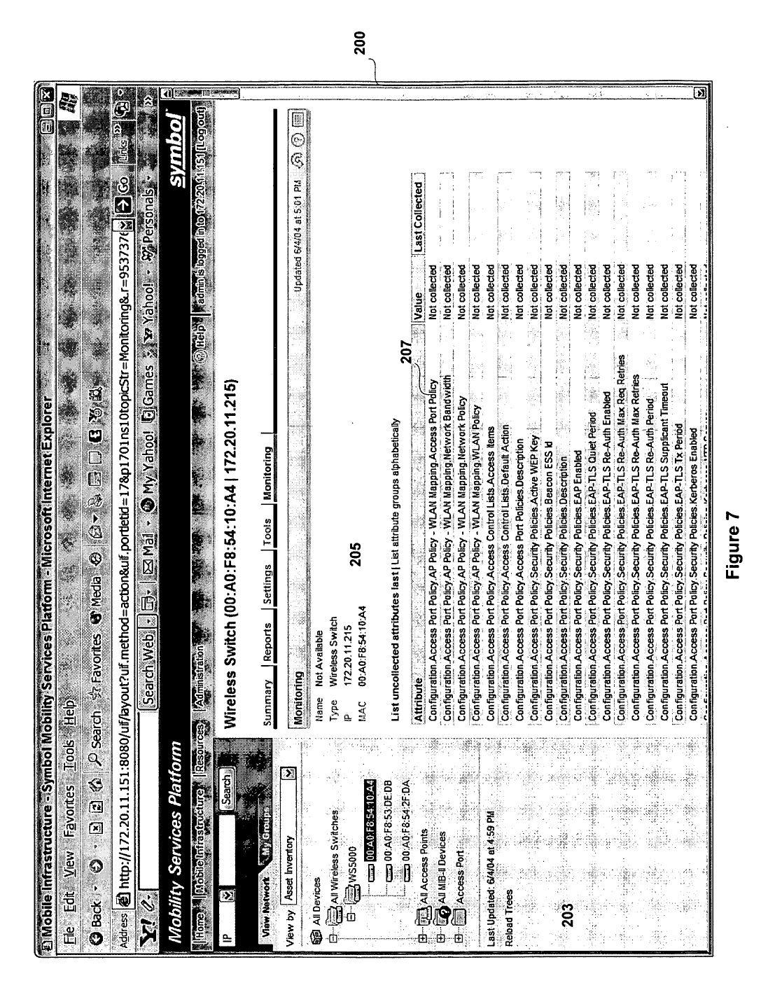

FIG. 7 shows an exemplary user interface display screen 200 displaying attributes. The display screen 200 includes a tree portion 203 which displays network assets in a tree form. In this exemplary view, the system administrator has selected to view the assets by inventory. The general categories of devices include wireless switches, access points, MIB-II devices and access ports. The system administrator has expanded the view to show the wireless switches and has selected a particular wireless switch (00:A0:F8:54:10:A4) to display additional information for as shown by the highlighting. The tree display of network assets will be described in greater detail below.

The display screen 200 further includes an information portion 205 which provides general information on the selected device as shown in FIG. 7. The display screen 200 also includes an attribute portion 207 which displays the attributes which are collected by the IWM system 60 for the selected wireless switch, including the attribute value and the time when the attribute was last collected. In this example, no attribute values are displayed because no values have actually been collected. However, the exemplary display 200 shows some exemplary attributes for which values may be displayed and an exemplary format of the display.

Those of skill in the art will understand that the described user interface screen is only exemplary and that the user interface 65 may include any number of display screens for use by a system administrator. The content of these additional screens may depend on the functionality that is being performed by the system administrator and several examples of functionality will be provided below.

The above description provided an example of the IWM system 60 monitoring the attributes of the mobile units 31-33 and 41-43. For the other devices that are part of the wireless portion of the network 1, e.g., the access point 30 and wireless switch 40, the IWM system 60 may discover these devices based on their support of protocols such as the wireless network management protocol (“WNMP”), extensible markup language (“XML”), simple network management protocol (“SNMP”), etc. The IWM system 60 may query these devices through the object definitions such as standard Management Information Base (“MIBs”) object definitions as defined by protocol Request for Comments (“RFCs”) or other user defined object definitions as defined, for example, in an enterprise MIB. Thus, the IWM system 60 may also include information on these and other network devices to give the system administrator a full view of the entire network.

However, agents that are similar to the above described wireless agents 55 may also be resident on other network devices to monitor attributes related to these devices. Thus, while the software component is referred to as a wireless agent, it is not limited to being resident on a wireless device, the wireless agent 55 may be resident on any network device whether it is part of the wired or wireless portion of the network 1 in order to provide attribute information to the IWM system 60.

In the previous description, it has been described that the IWM system 60 monitors the attributes from the various devices in the network 1. However, the IWM system 60 is not limited to the monitoring of devices. The IWM system 60 may also provide network management services such as the remote control of devices, the provisioning of devices and the configuration of devices. Other services may also be implemented by the IWM system 60.

The exemplary embodiment of the present invention may be considered a distributed system where the wireless agents 55 reside on the network devices and the IWM system 60 and its related services reside at a central location such as the network appliance 10. For a more complete description of an exemplary service based architecture which may be implemented by the IWM system 60, refer to U.S. patent application entitled “Service Oriented Platform Architecture for a Wireless Network” filed on an even date herewith, which is expressly incorporated by reference herein.

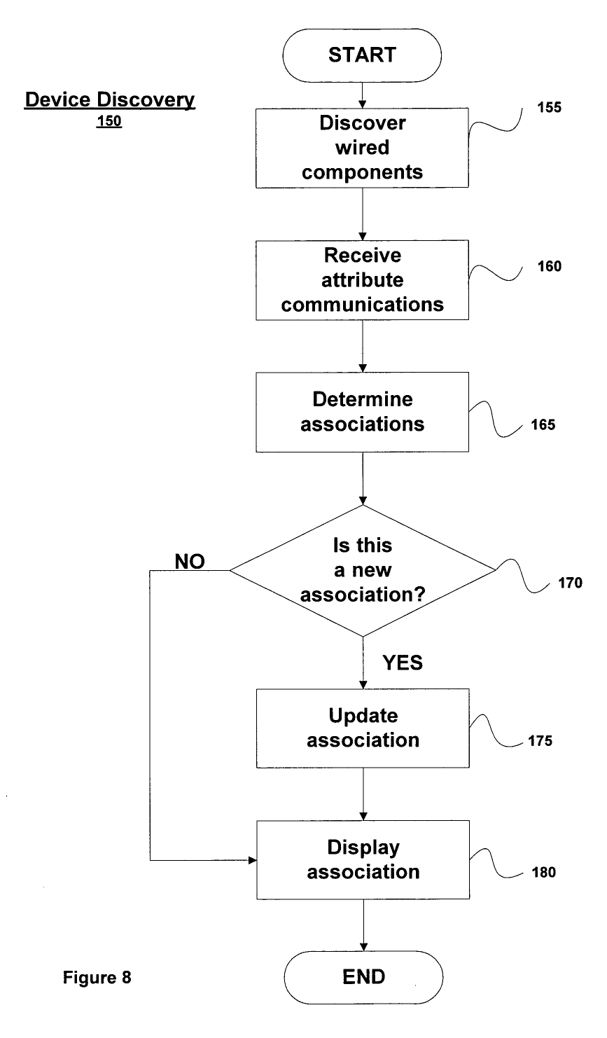

The following are several examples which show features and functionality of the IWM system 60 and the wireless agents 55. The first example of a functionality is device discovery for the network 1. This example will be described with reference to FIG. 8 which shows an exemplary method 150 for device discovery. In step 155, the IWM system 60 will discover each of the wired components in the network 1, e.g., the access point 30, the wireless switch 40, etc. As described above, the IWM system may discover these devices by querying the MIBs on these devices. Those of skill in the art will understand that some of these devices may not be “wired” to the network 1, e.g., an access point acting as a relay, but such devices may be discovered in the same manner.

In step 160, the IWM system 60 receives the attribute transmissions from the wireless agents 55 included in each of the mobile units 31-33 and 41-43. The wireless agent 55 on each device may be uniquely identified for the purpose of tracking the device/agent. Other manners of uniquely identifying the device may be through the MAC address or IP address. Thus, upon receiving each transmission, the IWM system 60 may uniquely identify each of the devices/agents from which the transmission originated.

In step 165, the IWM system 60 determines the associations between the mobile units 31-33 and 41-43 and the access point 30 and wireless switch 40. This determination may be performed in various manners. For example, when a mobile unit enters the range of an access point, the wireless agent may log into the access point as a user. Thus, the access point may contain information about the agents that have logged into the access point. In another example, the wireless agent 55 may transmit the attributes and the IWM system 60 may receive the attributes from one of the access point 30 or the wireless switch 40. Based on from where the transmission was received, the IWM system 60 may determine the association of the mobile unit. Another example of the determination of an association of a mobile unit is via events. For example, an event may be generated whenever a mobile unit roams from one AP to another AP.

In step 170, the IWM system determines if this is a new association. Referring back to FIG. 1, the IWM system 60 may make an initial determination based on the queries and the received transmissions that mobile units 31-33 are associated with access point 30 and mobile units 41-43 are associated with wireless switch 40.

However, since the devices are wireless mobile units, these associations may change very rapidly. Thus, the “picture” of the network will change as the devices move from place to place. For example, the mobile unit 31 may move out of the range of the access point 30 and move into the range of the wireless switch 40 changing its association. When the wireless agent 55 of the mobile unit 31 transmits attribute data through the wireless switch 40, the IWM system 60 will discover that the association has changed. As described above, this discovery may be made because each wireless agent 55 has a unique identifier. The IWM system 60 can identify the wireless agent 55 (and its associated device) regardless of the network device which relays the signal to the IWM system 60.

If the association is determined to be new in step 170, the process continues to step 175 where the IWM system will update the associations for the network 1. In step 180, the user interface 65 may display these associations, for example, in a tree view which allows the system administrator to see an end-to-end view of the network 1. At the completion of the process 150, the IWM system 60 will discover and display the entire topology of the network 1 and keep a continuous update of this topology.

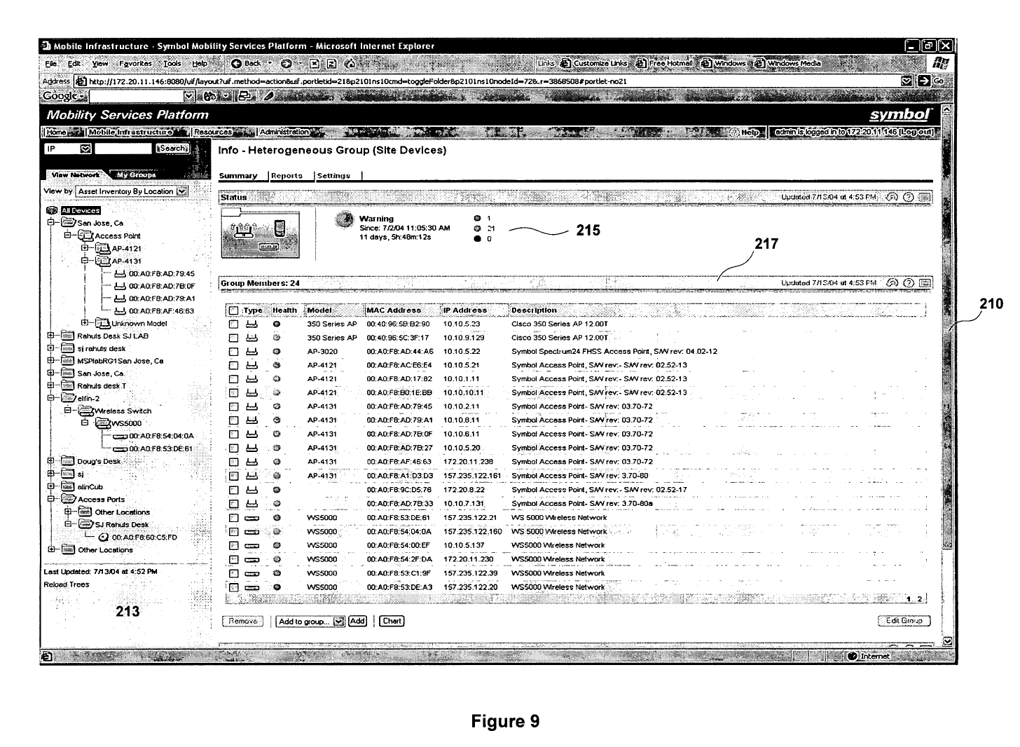

FIG. 9 shows a second exemplary display screen 210 for displaying network assets. As described above, the IWM system 60 may automatically discover the network topology and the user interface 65 may display this topology to the user. The display screen 210 may be an exemplary manner of displaying this topology to the user in a tree format. The tree section 213 shows the network topology for an exemplary network. In this example the topology is displayed by location. There are several locations which are shown by the first level of folders in the hierarchical tree, e.g., San Jose, Calif., Rahuls desk T, elfin-2, etc. These folders may be expanded to show the various devices which reside at the location. For example, the San Jose, Calif. folder has been expanded to show some APs at this location. Thus, the IWM system 60 is able to display the network topology to a user in a coherent manner. Those of skill in the art will understand that there may be other manners of displaying the network topology and that other grouping methods beside location may be used to display the topology (e.g., device type).

The display 210 also includes a status portion 215 and an attribute portion 217 as described above for display 200. In this example, the attribute portion 217 is displaying the type of the device, a health monitor, the model number, the MAC address, the IP address and a description of the device. The attributes and the grouping of these attributes may be displayed in any manner which the system administrator deems efficient for the specific purpose of the display.

This automatic discovery and network topology also provides a comprehensive list or database of all the wireless assets in the network 1. The IWM system provides a centralized and comprehensive list of network assets through its use of queries and attribute reception. Again, the system administrator may view these network assets in a variety of manners.

This network asset control may also aid in the identification of rogue devices which enter the network 1. For example, each authorized mobile unit should have a wireless agent 55. Thus, if the IWM system 60 is detecting a mobile unit which does not have a wireless agent 55 or a wireless agent ID that is not associated with the network 1, such a mobile unit may be a rogue device that is not authorized for access to network 1.

In a second example, the IWM system 60 allows the system administrator to monitor individual devices or groups of devices. For example, the system administrator can query for all devices which have an RF signal strength below a particular level. If the system administrator learns that a great number of such devices are in a particular location, it may indicate a problem or potential problem in that location. Such a query may be manual or there may be predetermined rules which provide the system administrator with an alarm or indication.

In another example of grouping, the system administrator may be made aware that the network is experiencing problems at a certain location. The system administrator may view the attributes of all the devices in that location to determine the root cause of the problem.

In a further example of grouping, the system administrator may be aware that a new application is being deployed to a set of devices. The system administrator may view the attributes of these devices in order to monitor the deployment and monitor the operation of the devices after the deployment. Those of skill in the art will understand that there are many other group views which may be used by a system administrator for maintenance and diagnostic purposes.

In addition, the system administrator may monitor an individual device for the purpose of troubleshooting the device. In this case, the system administrator may see all the information that a user is seeing and may be able to diagnose any problems the device is experiencing. Thus, device troubleshooting and repair may be performed remotely by the system administrator.

Therefore, in addition to remotely monitoring the device, e.g., mobile unit 31, the IWM system 60 may also allow the system administrator to remotely control the device. The wireless agent 55 may push attributes to the IWM system 60, but it may also pull attributes from the IWM system 60, i.e., the IWM system 60 may send a new value for an attribute to the wireless agent 55 which may then implement the new value in the device on which the wireless agent resides. In this manner, the system administrator may remotely control the device by sending attribute values to the device. Exemplary attributes that may be set by a system administrator include the maximum use and minimum free attributes for the CPU. If these are set remotely by the system administrator, an application on the mobile unit will not use more CPU than the set maximum value and also will make sure that the minimum free amount is available for use by applications.

Another example is a synchronize clock attribute which, when set, indicates that the mobile unit will periodically synchronize the internal clock with the network clock. A final example includes storage usage attributes. When such attribute limits are set, the mobile unit will not exceed the set storage limits. Those of skill in the art will understand that the above are only examples and there are any number of attributes that can be set to control and/or configure a mobile unit.

The IWM system 60 allows the system administrator to monitor the status of all the devices on network 1 including the ability to be notified of a particular problem. For example, the system administrator may receive an indication that the mobile unit 31 is operating slowly. There may be many reasons for slow operations such as a problem with the mobile unit 31, e.g., overloaded memory, low battery level, etc, or a problem with the network 1, e.g., too many devices connected to a single access point, a large download of software applications to mobile units, etc. The IWM system 60 allows the system administrator to see all the parameters for the network 1 and the mobile unit 31 to diagnose and fix the specific problem causing the slow performance. In addition, the IWM system 60 may be configured to provide other types of indications to the system administrator, e.g., e-mail notifications, pager notifications, etc.

This monitoring may also include historical data gathering on the network 1 which allows the system administrator to see historical trends and needs. For example, the system administrator may determine that the network 1 is busy on certain days in the month and may allocate additional resources for these days or may schedule routine maintenance around these days.

In a third example, the IWM system 60 may aid in the provisioning of software applications for the network 1. In this example, the system administrator may specify a software application which should be deployed on a group of devices, e.g., mobile units 31-33. As described above, the mobile units 31-33 will transmit attribute information when they are connected to the network 1. The IWM system 60 will determine their associations and may then push the software application to the mobile unit 31-33 through the device to which the mobile units 31-33 are using to connect to the network 1. This example shows that, in addition to the communication from the mobile unit 31-33 to the IWM system 60 through the transmission of attributes, the communication may also operate in the opposite direction, i.e., the IWM system 60 pushing data to the mobile units 31-33. Once the mobile unit 31-33 has received the new application, the wireless agent 55 may transmit an updated attribute to the IWM system 60 indicating that the application is now loaded on the mobile unit 31-33 and the IWM system 60 no longer needs to push the application to the particular device.

In a final example, the IWM system 60 may aid in the addition and configuration of new devices that are to be added to the network 1. When a new device or a set of new devices are added to the network 1, the IWM system 60 may discover these devices as described above. Upon connecting to the network 1, the IWM system 60 may contain configuration templates for these new devices. The configuration templates include attribute values for the devices which may be pushed from the IWM system 60 to the wireless agent 55 on the new devices so that the attribute values may be set and thereby the device may be remotely configured for operation on the network 1.

An example of this configuration may be that the system administrator enters a series or range of IP addresses or MAC addresses of the new devices. When a device having one of the IP addresses in the range connects to the network 1 for the first time, the IWM system 60 may send this configuration information. As a prerequisite, the IWM system may first push the wireless agent 55 to the device if the wireless agent 55 has not been pre-loaded onto the device. The wireless agent 55 will follow the communication protocol defined by the network server and therefore may be loaded onto any device which can communicate with the network server. The wireless agent 55 may be made further generic by implementing a wireless agent for any device using a specific operating system, e.g., Windows CE. Since the wireless agent 55 will be primarily be collecting information which is interfaced through the operating system, a wireless agent 55 may be created which works on any device that runs the specific operating system.

The above description provided several examples of features and functionality for the IWM system 60. However, other uses of the information that is centralized in the IWM system 60 for the entire network 1 will be apparent to those of skill in the art.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A system, comprising:
a receiving element receiving monitored attributes from a plurality of devices in a network;
a storing element storing the monitored attributes, wherein corresponding attributes from the plurality of devices are stored using standard attributes names; and
an output element outputting the monitored attributes to a user.

2. The system of claim 1, further comprising:
a control element controlling operation of one of the devices by transmitting a value for one of the monitored attributes to the one of the devices, wherein the one of the devices sets the one of the monitored attributes to the value.

3. The system of claim 1, wherein the plurality of devices include a wireless device.

4. The system of claim 3, wherein the wireless device includes one of a personal digital assistant, a laptop computer, a handheld computer, a mobile phone, a pager and a barcode scanning device.

5. The system of claim 1, wherein the network is one of a local area network and a wide area network.

6. The system of claim 1, further comprising:
a query element querying for one of the plurality of devices in the network, the one of the devices being a wired device, wherein a response to the query indicates an existence of the wired device in the network.

7. The system of claim 6, wherein the response includes attributes for the wired device.

8. The system of claim 6, wherein the querying is based on support of protocols by the wired device.

9. The system of claim 6, wherein the wired device includes one of an access point and a wireless switch.

10. The system of claim 1, wherein the output element formats the received attributes for visual display to the user.

11. The system of claim 1, wherein at least one of the devices includes an agent for transmitting the attributes.

12. The system of claim 1, further comprising:
a topology element discovering a topology for the network based on the monitored attributes of the plurality of devices.

13. The system of claim 12, wherein the output element formats the topology for display to the user in a hierarchical tree format.

14. The system of claim 1, further comprising:
a provisioning element providing provisioning information to one of the plurality of devices based on the monitored attributes received by the system for the one of the plurality of devices.

15. A method, comprising the steps of:
receiving monitored attributes from a plurality of devices in a network;
storing the monitored attributes, wherein corresponding attributes from the plurality of devices are stored using standard attributes names; and
outputting the monitored attributes to a user.

16. The method of claim 15, further comprising the step of:
controlling operation of one of the devices by transmitting a value for one of the monitored attributes to the one of the devices, wherein the one of the devices sets the one of the monitored attributes to the value.

17. The method of claim 15, further comprising the step of:
discovering a topology for the network based on the monitored attributes of the plurality of devices.

18. The method of claim 15, further comprising the step of:
providing provisioning information to one of the plurality of devices based on the monitored attributes received for the one of the plurality of devices.

19. The method of claim 15, wherein the monitored attributes include one of wireless signal attributes, wireless throughput attributes, scanning attributes, user authentication attributes, device attributes, static attributes, system performance attributes, system boot attributes and wireless association attributes.

20. The method of claim 15, wherein the plurality of devices include a wireless device.

21. The method of claim 15, further comprising the steps of:
setting a policy for transmission of the attributes by one of the devices; and
transmitting the policy to the one of the devices.

22. A wireless device, comprising:
a protocol for communicating with a network device; and
a wireless agent collecting monitored attributes from the wireless device and transmitting, via the protocol, the monitored attributes to the network device.

23. The wireless device of claim 22, wherein the monitored attributes include one of wireless signal attributes, wireless throughput attributes, scanning attributes, user authentication attributes, device attributes, static attributes, system performance attributes, system boot attributes and wireless association attributes.

24. The wireless device of claim 22, wherein the protocol is an HTTP protocol and the attributes are transmitted in an XML format.

25. The wireless device of claim 22, wherein the wireless device is one of a personal digital assistant, a laptop computer, a handheld computer, a mobile phone, a pager and a barcode scanning device.

26. The wireless device of claim 22, wherein the wireless agent receives a policy from the network device and the transmission of the monitored attributes is controlled by the policy.

27. The wireless device of claim 22, wherein the wireless agent receives a value corresponding to one of the monitored attributes for the wireless device and the wireless agent sets the one of the monitored attributes to the value.

28. The wireless device of claim 22, wherein the monitored attributes include software resource attributes that are resident on the wireless device and the wireless device further receives software provisioning information based on the software resource attributes.
